(19) United States
(12) Patent Application Publication
(10) Pub. No.: US 2026/0061950 A1
(43) Pub. Date: Mar. 5, 2026

(54) WIRING HARNESS CLIP FOR COMPONENT OF VEHICLE

(71) Applicant: GM Global Technology Operations LLC, Detroit, MI (US)

(72) Inventors: Yeongmin Jo, Incheon (KR); Junbum Lee, Gwangmyeong-si (KR); Kyungsoo Lim, Gyeonggi-do (KR)

(73) Assignee: GM Global Technology Operations LLC, Detroit, MI (US)

(21) Appl. No.: 18/824,783

(22) Filed: Sep. 4, 2024

(51) Int. Cl. B60R 16/02; H02G 3/32

(52) U.S. Cl. CPC B60R 16/0215; H02G 3/32

(57) ABSTRACT

A deformable wiring harness clip includes a body, a plurality of wedged teeth, a wire hole, a tension release lever, and a pair of hooks. The body includes an interior portion, an exterior portion, a first side, and a second side. The plurality of wedged teeth are integrated with the interior portion of the body. Each of the plurality of wedged teeth has an angle defined from the first side of the body to the second side of the body. The wire hole is defined by the plurality of wedged teeth and is operable between a first size and a second size larger than the first size. The tension release lever is integrated with the body, protrudes away from the body, and is operable between a first state and a second state. The pair of hooks are integrated with the second side of the body.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a wiring harness clip and wiring harness for a component that may be included with a vehicle.

Many components included with a vehicle include a wiring harness. For example, a passenger airbag assembly may be equipped with a wiring harness. The wiring harness provides an electrical connection between the passenger airbag assembly and other electrical components of the vehicle when the passenger airbag assembly is installed at the vehicle. However, the passenger airbag assembly is commonly manufactured at a location that differs from the location of vehicle assembly prior to installation of an airbag assembly at the vehicle. As a result, the passenger airbag assembly must be shipped from a separate manufacturing location to the location where the vehicle is assembled. During this shipping process, the wiring harness may be susceptible to damage, quality issues, and other factors that may affect proper operation of the passenger airbag assembly when installed at the vehicle.

For example, the shipping process may cause the wiring harness to crimp, improperly bend, or break away from the passenger airbag assembly. As a result, the passenger airbag assembly may not function properly with a damaged wiring harness. To prevent damage to the wiring harness, the wiring harness may be minimally secured to the passenger airbag assembly using tape, rubber bands, or something of the like. However, taping or banding the wiring harness to the passenger airbag assembly is not a secure or robust solution to prevent damage to the wiring harness during shipment. Additionally, when installing the passenger airbag assembly at the vehicle, the wiring harness may have excess wire length. As a result, an excessive amount of wiring may remain unsecured when installed at the vehicle, which may interfere or encumber other components installed at the vehicle.

### SUMMARY

One aspect of the disclosure provides a deformable wiring harness clip. The deformable wiring harness clip includes a body, a plurality of wedged teeth, a wire hole, a tension release lever, and a pair of hooks. The body includes an interior portion, an exterior portion opposing the interior portion, a first side, and a second side opposing the first side. The plurality of wedged teeth are integrated with the interior portion of the body. Each of the plurality of wedged teeth has an angle defined from the first side of the body to the second side of the body. The wire hole is defined by the plurality of wedged teeth and is operable between a first size and a second size larger than the first size. The tension release lever is integrated with the body, protrudes away from the body, and is operable between a first state and a second state. The pair of hooks are integrated with the second side of the body.

Implementations of the disclosure may include one or more of the following optional features. In some examples, the first state of the tension release lever is a static state and corresponds to the first size of the wire hole.

In some implementations, the second state of the tension release lever is a deformed state and corresponds to the second size of the wire hole.

In some aspects, the pair of hooks include rounded tips.

In some configurations, the plurality of wedged teeth are configured to engage with a wire of a wiring harness assembly. In some further configurations, the wire has a bi-directional linear path relative to the wire hole when the tension release lever is in the second state. In some other further configurations, the wire has a mono-directional linear path relative to the wire hole when the tension release lever is in the first state. The mono-directional linear path is defined by movement of the wire from the first side of the body toward the second side of the body. In some other further configurations, the deformable wiring harness clip further includes a wire insertion slot defined by the tension release lever and extending from the exterior portion of the body to the wire hole. In some other even further configurations, the wire insertion slot is operable between a first size and a second size larger than the first size. The second size of the wire insertion slot is sized to accommodate the wire.

In some examples, the deformable wiring harness clip further includes a mounting point integrated with the body and fixedly attached to a vehicle component.

Another aspect of the disclosure provides a vehicle component. The vehicle component includes a wiring harness assembly and a deformable wiring harness clip. The wiring harness assembly is operable between a first position and a second position. The wiring harness assembly includes a wire including a connector end, a connector coupled to the connector end of the wire, the connector including a pair of hook receptacles, and a stopper fixedly attached to the wire. The deformable wiring harness clip includes a body, a plurality of wedged teeth, a wire hole, a tension release lever, and a pair of hooks. The body includes an interior portion, an exterior portion opposing the interior portion, a first side, and a second side opposing the first side. The plurality of wedged teeth are integrated with the interior portion of the body. Each of the plurality of wedged teeth has an angle defined from the first side of the body to the second side of the body. The wire hole is defined by the plurality of wedged teeth and is operable between a first size and a second size larger than the first size. The tension release lever is integrated with the body, protrudes away from the body, and is operable between a first state and a second state. The pair of hooks are integrated with the second side of the body.

Implementations of this aspect of the disclosure may include one or more of the following optional features. In some examples, the first state of the tension release lever is a static state with the wire having a mono-directional linear path relative to the wire hole when the wire hole is the first size and the tension release lever is in the first state. The mono-directional linear path is defined from the first side of the body toward the second side of the body.

In some implementations, the second state of the tension release lever is a deformed state with the wire having a bi-directional linear path relative to the wire hole when the wire hole is the second size and the tension release lever is in the second state.

In some aspects, the pair of hooks of the deformable wiring harness clip are disposed in the pair of hook receptacles of the connector when the wiring harness assembly is in the first position.

In some configurations, the pair of hooks of the deformable wiring harness clip are removed from the pair of hook receptacles of the connector and the stopper is proximate to the deformable wiring harness clip when the deformable wiring harness clip is in the second position. The stopper has a size greater than the first size of the wire hole.

Yet another aspect of the disclosure provides a vehicle. The vehicle includes a vehicle component. The vehicle component includes a wiring harness assembly and a deformable wiring harness clip. The wiring harness assembly is operable between a first position and a second position. The wiring harness assembly includes a wire including a connector end, a connector coupled to the connector end of the wire with the connector including a pair of hook receptacles, and a stopper fixedly attached to the wire. The deformable wiring harness clip includes a body, a plurality of wedged teeth, a wire hole, a tension release lever, and a pair of hooks. The body includes an interior portion, an exterior portion opposing the interior portion, a first side, and a second side opposing the first side. The plurality of wedged teeth are integrated with the interior portion of the body and have an angle defined from the first side of the body to the second side of the body. The wire hole is defined by the plurality of wedged teeth and is operable between a first size and a second size larger than the first size. The tension release lever is integrated with the body, protrudes away from the body, and is operable between a first state and a second state. The pair of hooks are integrated with the second side of the body.

Implementations of this aspect of the disclosure may include one or more of the following optional features. In some examples, the first state of the tension release lever is a static state with the wire having a mono-directional linear path relative to the wire hole when the wire hole is the first size and the tension release lever is in the first state. The mono-directional linear path is defined from the first side of the body toward the second side of the body.

In some implementations, the second state of the tension release lever is a deformed state with the wire having a bi-directional linear path relative to the wire hole when the wire hole is the second size and the tension release lever is in the second state.

In some aspects, the pair of hooks of the deformable wiring harness clip are disposed in the pair of hook receptacles of the connector when the wiring harness assembly is in the first position.

In some configurations, the pair of hooks of the deformable wiring harness clip are removed from the pair of hook receptacles of the connector and the stopper is proximate to the deformable wiring harness clip when the deformable wiring harness clip is in the second position. The stopper has a size greater than the first size of the wire hole.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including a vehicle component according to the present disclosure;

FIG. 2 is a perspective view of a vehicle component including a wiring harness clip and a wiring harness assembly according to the present disclosure, the wiring harness assembly being in a first position;

FIG. 3 is an enlarged partial perspective view of the wiring harness clip and the wiring harness assembly of FIG. 2;

FIG. 4 is an enlarged partial perspective view of the wiring harness clip and the wiring harness assembly of FIG. 2;

FIG. 5 is a cross-sectional view of the wiring harness clip and the wiring harness assembly of FIG. 4;

FIG. 6 is a perspective view of the vehicle component of FIG. 2 including the wiring harness clip and the wiring harness assembly, the wiring harness assembly being in a second position;

FIG. 7A is a perspective view of a wiring harness clip according to the present disclosure including a tension release lever in a static state; and

FIG. 7B is a perspective view of the wiring harness clip of FIG. 7A including the tension release lever in a deformed state.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

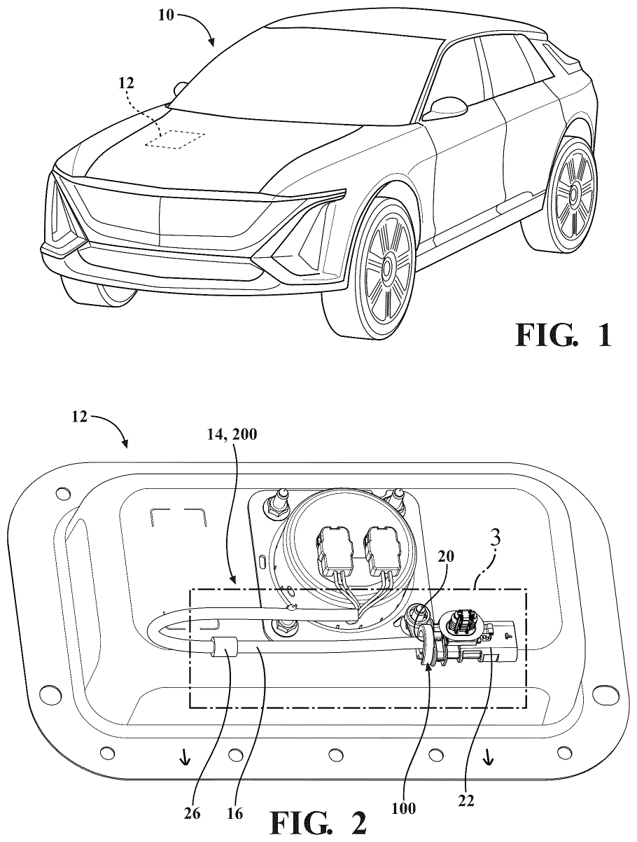

With reference to FIGS. 1 and 2, a vehicle 10 includes a vehicle component 12, such as, for example, an airbag assembly. It should be noted, however, that the vehicle component 12 may be any vehicle component compatible within the context of this disclosure. The vehicle component 12 includes a wiring harness assembly 14. The wiring harness assembly 14 provides electrical connection between the vehicle component 12 and other electrical components included at the vehicle 10. The wiring harness assembly 14 includes a wire 16 that is generally tubular in shape.

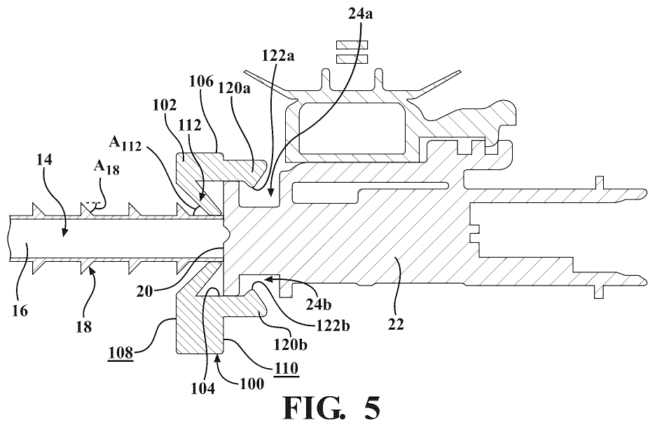

Referring now to FIGS. 2-5, the wire 16 may include a single wire or a compilation of wires as required by the vehicle component 12. In some instances, the wire 16 may be concealed with a covering, sheath, or wiring insulation as required by the vehicle component 12. In some examples, the wire 16 may be corrugated, which may advantageously assist in securing the wire 16. In other examples, the wire 16 may be free of corrugation and may still be secured and operable with the wiring harness assembly 14, as described herein. If the wire 16 is corrugated, the corrugation may be defined by a plurality of corrugated teeth 18 (FIG. 5) included at the wire 16. The plurality of corrugated teeth 18 are positioned at a corrugation angle A₁₈. The corrugation angle A₁₈ is defined as the angle at which each of the corrugated teeth 18 extends with respect to the wire 16. For example, if each of the corrugated teeth 18 is entirely perpendicular to the wire 16, the corrugation angle A₁₈ is ninety (90) degrees.

The wire 16 also includes a connector end 20 that is coupled to a connector 22. The connector 22 may be any practicable connector configured to electrically interface with an electrical component when installed at the vehicle 10. Regardless of the variety of the connector 22, the connector 22 includes a pair of hook receptacles 24a, 24b. The pair of hook receptacles 24a, 24b are configured to receive components, described below, included at the vehicle component 12. The wiring harness assembly 14 also includes a stopper 26. The stopper 26 is fixedly attached to the wire 16 and may be at any location along the wire 16 as required by the vehicle component 12. The stopper 26 has a thickness that is greater than a thickness of the wire 16.

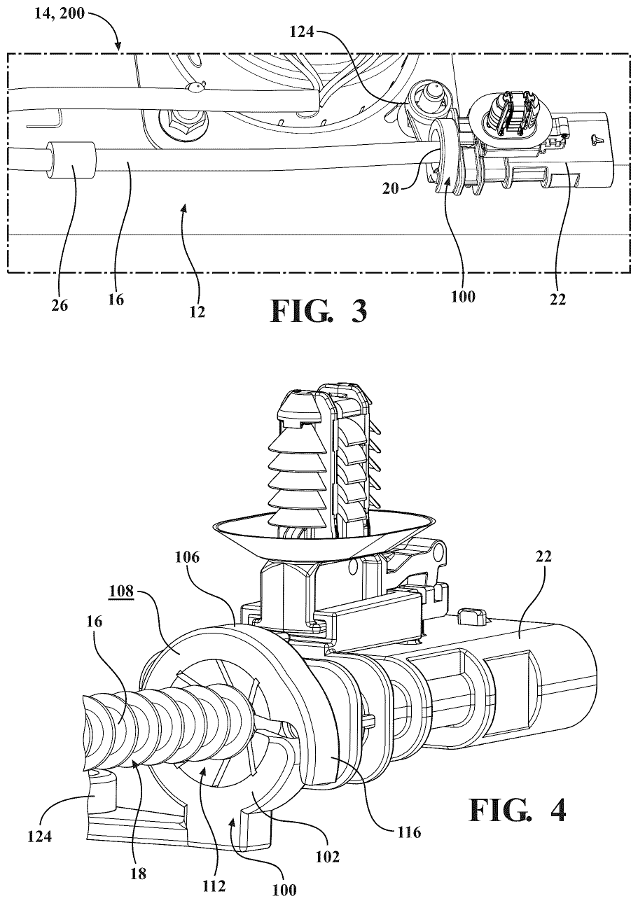

With reference to FIGS. 3-5, the vehicle component 12 also includes a wiring harness clip 100. The wiring harness clip 100 has a body 102 that is a plastically deformable material configured to accommodate plastic deformation. For example, the body 102 may selectively deform when force is applied to the wiring harness clip 100. In some instances, the body 102 of the wiring harness clip 100 may be an acrylonitrile-butadiene-styrene (ABS) or polypropylene plastic or similar material. The wiring harness clip 100 is positioned at a location on the vehicle component 12 that is at or near the positioning of the wiring harness assembly 14. In other words, the wiring harness clip 100 and the wiring harness assembly 14 are positioned close enough to one another to enable interaction during operation of the wiring harness clip 100 and the wiring harness assembly 14.

The body 102 may have a generally rounded shape and includes an interior portion 104 and an exterior portion 106 opposing the interior portion 104. The body 102 also includes a first side 108 and a second side 110 opposing the first side 108. Integrated with the interior portion 104 of the body 102 is a plurality of wedged teeth 112. The plurality of wedged teeth 112 may include any quantity practicable based on the specific configuration of the wiring harness clip 100. Similar to the body 102, the plurality of wedged teeth 112 are configured to facilitate plastic deformation. As a result, the plurality of wedged teeth 112 may slightly flex during operation of the wiring harness clip 100 and the wiring harness assembly 14, the details of which will be described in greater detail below. The plurality of wedged teeth 112 are positioned at a teeth angle A₁₁₂ with respect to the wire 16 and with respect to the interior portion 104 of the body 102. The wire 16 and the interior portion 104 are parallel to one another when the wire 16 is engaged with the wiring harness clip 100. The teeth angle A₁₁₂ angles the plurality of wedged teeth 112 from the first side 108 toward the second side 110.

The plurality of wedged teeth 112 define a wire hole 114 that is configured to receive the wire 16. The wire hole 114 is generally circular in shape and extends between the first side 108 and the second side 110 of the body 102 of the wiring harness clip 100. The body 102 also includes a tension release lever 116 that is integrated with the body 102. The tension release lever 116 protrudes away from the body 102 and provides an interface for a finger or hand of a user to interact with the wiring harness clip 100 during operation. The tension release lever 116 may be configured as a tab, a ridge, or any practicable protrusion that enables a user to provide force to the tension release lever 116. The tension release lever 116 defines a wire insertion slot 118 that extends from the exterior portion 106 of the body 102 to the wire hole 114. For example, the wire insertion slot 118 separates the body 102 and accommodates access to the wire hole 114 from the exterior portion 106.

A pair of hooks 120a, 120b are integrated with the second side 110 of the body 102 and protrude away from the body 102. The pair of hooks 120a, 120b may be any practicable style or variety that corresponds to and are disposed within the pair of hook receptacles 24a, 24b of the wiring harness assembly 14 during operation. Furthermore, the pair of hooks 120a, 120b may be positioned at any location on the second side 110 of the body 102 that corresponds to the positioning of the pair of hook receptacles 24a, 24b. The pair of hooks 120a, 120b include a pair of rounded tips 122a, 122b. The pair of rounded tips 122a, 122b enable smooth entry into and exit from the pair of hook receptacles 24a, 24b during operation, the details of which described in greater detail below.

Additionally, a mounting point 124 is integrated with the body 102 of the wiring harness clip 100. The mounting point 124 may be of any style or variety that facilitates fixedly mounting the wiring harness clip 100 to the vehicle component 12. In doing so, the wiring harness clip 100 is fixed in relation to the vehicle component 12.

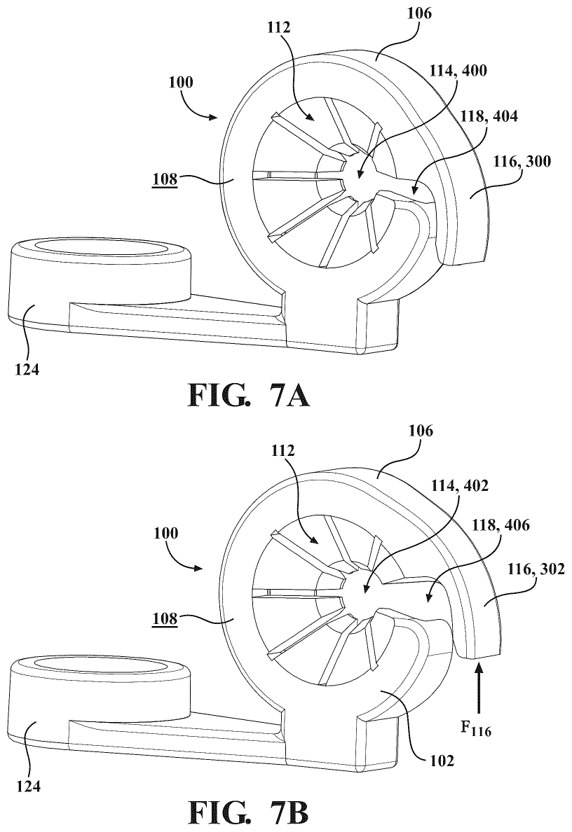

Referring now to FIGS. 2-7B, during operation, the wiring harness assembly 14 may engage with the wiring harness clip 100 in a variety of ways. The wire hole 114 is sized and configured to receive the wire 16. The wire 16 is configured to linearly travel through the wire hole 114. The position of the wire 16 at the wire hole 114 partially defines a position of the wiring harness assembly 14. For example, when the wiring harness assembly 14 is in a first position 200 (FIG. 2), the connector end 20 of the wire 16 is positioned at the wiring harness clip 100. Additionally, the pair of hooks 120a, 120b of the wiring harness clip 100 are disposed in the pair of hook receptacles 24a, 24b of the connector 22, securing the connector 22 to the wiring harness clip 100. The first position 200 may benefit the wiring harness assembly 14 during shipment of the vehicle component 12, or during scenarios when the vehicle component 12 is uninstalled from the vehicle 10. Because the pair of hooks 120a, 120b are disposed within the pair of hook receptacles 24a, 24b in the first position 200, the wiring harness assembly 14 is secured to wiring harness clip 100 and, thus, secured to the vehicle component 12. Securing the wiring harness assembly 14 to the wiring harness clip 100 advantageously reduces the potential of damage to the wiring harness assembly 14 that may occur during shipment or assembly of the vehicle component 12.

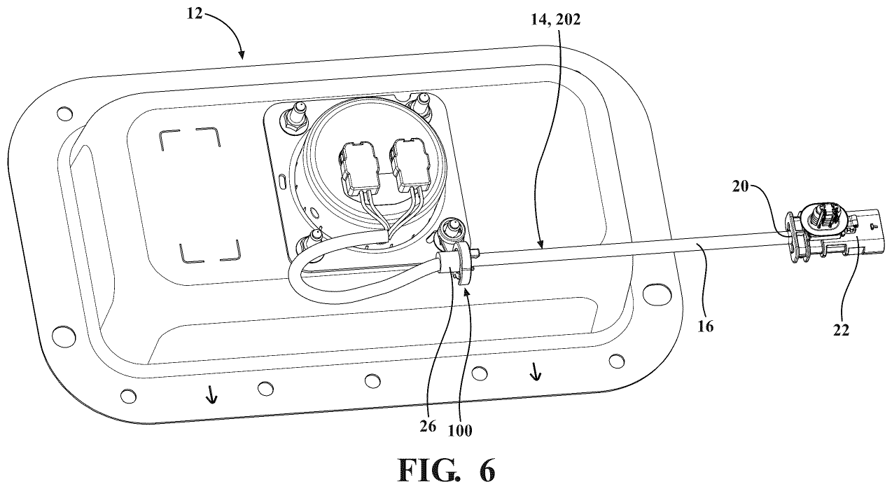

When the wiring harness assembly 14 is in a second position 202 (FIG. 6), the connector end 20 of the wire 16 is positioned away from the wiring harness clip 100. Additionally, the pair of hooks 120a, 120b of the wiring harness clip 100 are removed from the pair of hook receptacles 24a, 24b of the connector 22 in the second position 202 of the wiring harness assembly 14. When the pair of hooks 120a, 120b are removed from the pair of hook receptacles 24a, 24b, the connector 22 is uncoupled from the wiring harness clip 100. The stopper 26 is proximate to the wiring harness clip 100 when the wiring harness assembly 14 is in the second position 202. Because the stopper 26 is larger than the wire hole 114, the stopper 26 is prevented from traveling through the wire hole 114. As a result, the second position 202 of the wiring harness assembly 14 may be at any position when the pair of hooks 120a, 120b are removed from the pair of hook receptacles 24a, 24b while the stopper 26 remains proximate to the first side 108 of the body 102 of the wiring harness clip 100. The second position 202 may benefit the wiring harness assembly 14 when the vehicle component 12 is installed at the vehicle. In other words, a user may pull the connector 22 away from the wiring harness clip 100 to connect the connector 22 to another electrical component included in the vehicle 10. In the second position 202, the connector 22 may operably extend from the second side 110 of the body 102 of the wiring harness clip 100 depending on the configuration and/or placement of the vehicle component 12 and/or other electrical components included with the vehicle 10. The wire 16 remains secured at the wiring harness clip 100 regardless of whether the wiring harness assembly 14 is in the first position 200 or the second position 202.

The rounded tips 122a, 122b of the pair of hooks 120a, 120b facilitate coupling the connector 22 to the wiring harness clip 100 or uncoupling the connector 22 from the wiring harness clip 100 without significant resistance from the pair of hooks 120a, 120b. The pair of hooks 120a, 120b may be selectively disposed and removed from the pair of hook receptacles 24a, 24b as a result of a pulling motion by a user. For example, a user may pull the connector 22 away from the wiring harness clip 100 to connect the connector 22 with an electrical component. In some instances, a user may secure the connector 22 to the wiring harness clip 100 by pushing the connector 22 towards the wiring harness clip 100 until the pair of hooks 120a, 120b clip into the pair of hook receptacles 24a, 24b. The direction of linear travel of the wire 16 through the wire hole 114 may vary depending on a state of the tension release lever 116, described in greater detail below.

With further reference to FIGS. 2-7B, the tension release lever 116 of the wiring harness clip 100 is operable between a first, static state 300 and a second, deformed state 302. For example, the static state 300 may be defined by the body 102 of the wiring harness clip 100 not being plastically deformed. The static state 300 of the tension release lever 116 corresponds to a first size 400 of the wire hole 114 and a first size 404 of the wire insertion slot 118. The first size 400 of the wire hole 114 is sized to snuggly and firmly accept the wire 16. For example, the plurality of wedged teeth 112 firmly press against the wire 16 when the wire hole 114 is at the first size 400. The first size 400 of the wire hole 114 enables a mono-directional linear path of the wire 16. For example, the wire 16 is able to move linearly in one direction, from the first side 108 of the body 102 toward the second side 110 of the body 102, when the wire hole 114 is at the first size 400. The first size 404 of the wire insertion slot 118 is sized to prevent the wire 16 from traveling through the wire insertion slot 118. In other words, the wire 16 is too large to fit in the wire insertion slot 118 when the wire insertion slot 118 is at the first size 404. As a result, if the wire 16 is installed in the wire hole 114, the wire 16 is prevented from exiting the wire hole 114 through the wire insertion slot 118.

The mono-directional linear motion of the wire 16 is due to the teeth angle A₁₁₂ of the plurality of wedged teeth 112. The plurality of wedged teeth 112 enable movement of the wire 16 from the first side 108 toward the second side 110, as the teeth angle A₁₁₂ is defined from the first side 108 of the body 102 to the second side 110 of the body 102. The mono-directional linear travel of the wire 16 may occur when a user pulls the connector 22 away from the wiring harness clip 100. The teeth angle A₁₁₂ prevents backward movement of the wire 16 (i.e., movement from the second side 110 of the body 102 toward the first side 108 of the body 102). For example, the first size 400 of the wire hole 114 prevents re-engagement of the pair of hooks 120a, 120b with the hook receptacles 24a, 24b as a result of the engagement of the plurality of wedged teeth 112 with the wire 16. The restricted movement of the wire 16 is due to the teeth angle A₁₁₂ of the plurality of wedged teeth 112 extending from the first side 108 toward the second side 110. The plurality of wedged teeth 112 may have a degree of plastic deformation toward the second side 110 of the body 102 (i.e., away from the wire 16) when the wire 16 travels from the first side 108 toward the second side 110. The plastic deformation of the plurality of wedged teeth 112 reduces the amount of grip applied by the plurality of wedged teeth 112 on the wire 16 and enables the mono-directional travel toward the second side 110 of the body 102. The plurality of wedged teeth 112 may plastically deform toward the first side 108 of the body 102 (i.e., toward the wire 16) if an attempt is made to pull the wire 16 toward the first side 108 of the body 102. If the plurality of wedged teeth 112 plastically deform toward the wire 16, the plurality of wedged teeth 112 will grip the wire 16 to a greater extent due to the teeth angle A₁₁₂. Thus, the teeth angle A₁₁₂ and engagement of the plurality of wedged teeth 112 with the wire 16 prohibits travel of the wire 16 from the second side 110 toward the first side 108 of the body 102 when the wire hole 114 is at the first size 400.

With further reference to FIGS. 2-7B, if the wire 16 is of the corrugated variety, the corrugation angle A₁₈ of the plurality of corrugated teeth 18 may be equivalent or nearly equivalent to the teeth angle A₁₁₂ of the plurality of wedged teeth 112. As the wire 16 is translated from the first side 108 toward the second side 110, the plurality of corrugated teeth 18 may slip past the plurality of wedged teeth 112 due to the similar angles A₁₈, A₁₁₂. When the wire hole 114 is at the first size 400, the corrugated teeth 18 of the wire 16 are prevented from traveling through the plurality of wedged teeth 112 from the second side 110 towards the first side 108. For example, the corrugated teeth 18 may engage the plurality of wedged teeth 112 when the wire 16 is translated toward the first side 108, in addition to the plurality of wedged teeth 112 engaging the wire 16.

The tension release lever 116 transitions from the first, static state 300 to the second, deformed state 302 in response to an applied lever force F₁₁₆. For example, the body 102 of the wiring harness clip 100 plastically deforms in response to the lever force F₁₁₆ being applied to the tension release lever 116. The deformed state 302 of the tension release lever 116 directly corresponds to the wire hole 114 having a second size 402. Likewise, the deformed state 302 of the tension release lever 116 directly corresponds to the wire insertion slot 118 having a second size 406. The second size 402 of the wire hole 114 is larger than the first size 400 of the wire hole 114. Similarly, the second size 406 of the wire insertion slot 118 is larger than the first size 404 of the wire insertion slot 118. The varying size of the wire hole 114 and the wire insertion slot 118 is accommodated by the plastic deformation of the body 102 of the wiring harness clip 100.

The plurality of wedged teeth 112 are free from direct engagement with the wire 16 when the wire 16 is positioned within the wire hole 114 having the second size 402 as compared to the first size 400 of the wire hole 114. In some instances, the plurality of wedged teeth 112 may be completely disengaged from the wire 16 when the wire hole 114 is at the second size 402. As a result, a bi-directional, linear path of the wire 16 through the wire hole 114 is accommodated. In other words, when the tension release lever 116 is in the deformed state 302, the connector 22 may transition either toward the wiring harness clip 100 or away from the wiring harness clip 100.

For example, when the connector 22 is moved towards the wiring harness clip 100, the wire 16 is free to travel through the wire hole 114 from the second side 110 of the body 102 towards the first side 108 of the body 102. When the connector 22 is moved away from the wiring harness clip 100, the wire 16 travels through the wire hole 114 from the first side 108 of the body 102 towards the second side 110 of the body 102. The wiring harness assembly 14 may be transitioned between the first position 200 and the second position 202, as a result of the bi-directional, linear travel of the wire 16 when the tension release lever 116 is in the deformed state 302 and the wire hole 114 is at the second size 402. The wiring harness assembly 14 is thus selectively operable to transition from either the first position 200 to the second position 202 or the second position 202 to the first position 200 depending on the state 300, 302 of the tension release lever 116.

Referring still to FIGS. 2-7B and as stated above, the second size 406 of the wire insertion slot 118 is larger than the first size 404 of the wire insertion slot 118. The second size 406 of the wire insertion slot 118 is larger than the wire 16, which enables the wire 16 to travel through the wire insertion slot 118. As an example, the wire 16 may be installed into the wire hole 114 during assembly of the vehicle component 12 by the lever force F₁₁₆ being applied to the tension release lever 116. The lever force F₁₁₆ transitions the tension release lever 116 from the first, static state 300 to the second, deformed state 302 and, as a result, transitions the wire insertion slot 118 from the first size 404 to the second size 406. At this point, the wire 16 can be inserted through the wire insertion slot 118 and into the wire hole 114. In a similar but opposite manner, the wire 16 may be removed from the wire hole 114 to, for example, provide service to the vehicle component 12. In doing so, the wire 16 may be removed through the wire insertion slot 118 when the wire insertion slot 118 is at the second size 406.

When the lever force F₁₁₆ applied to the tension release lever 116 is removed, the tension release lever 116 is transitioned from the second, deformed state 302 to the first, static state 300 as a result of the plastic deformation properties of the body 102 of the wiring harness clip 100. In doing so, the tension release lever 116 returns to the static state 300, the wire hole 114 returns to the first size 400, and the wire insertion slot 118 returns to the first size 404.

Referring again to FIGS. 1-7B, the connector 22 is secured to the wiring harness clip 100 when the wiring harness assembly 14 is in the first position 200. As a result, the vehicle component 12 may be shipped from its location of manufacture to the location of vehicle assembly with little to no risk of damage to the wiring harness assembly 14. When installing the vehicle component 12 at the vehicle 10, a user may pull the connector 22 away from the wiring harness clip 100. In doing so, the wire 16 travels through the wire hole 114 from the first side 108 toward the second side 110 of the body 102. This transitions the wiring harness assembly 14 from the first position 200 to the second position 202. Mono-directional linear travel of the wire 16 through the wire hole 114 is accommodated due to the teeth angle A₁₁₂ of the plurality of wedged teeth 112 being angled from the first side 108 toward the second side 110. The wire 16 is prohibited from traveling from the second side 110 to the first side 108 when the tension release lever 116 is in the static state 300. In this regard, the connector 22 may not re-engage with the wiring harness clip 100 when the tension release lever 116 is in the static state 300.

When the lever force F₁₁₆ is applied to the tension release lever 116, the body 102 of the wiring harness clip 100 undergoes plastic deformation and the tension release lever 116 transitions from the static state 300 to the deformed state 302. Additionally, the wire hole 114 transitions from the first size 400 to the second size 402 and the wire insertion slot 118 transitions from the first size 404 to the second size 406. The second size 402 of the wire hole 114 accommodates bi-directional, linear travel of the wire 16 through the wire hole 114, as the second size 402 of the wire hole 114 is larger than the first size 400 of the wire hole. This allows the connector 22 to re-engage with the wiring harness clip 100 as the wire 16 is able to linearly travel from the second side 110 toward the first side 108 of the body 102. Additionally, the second size 406 of the wire insertion slot 118 is sized larger than the wire 16. This allows the wire 16 to be removed from or inserted into the wire hole 114 through the wire insertion slot 118. When the lever force F₁₁₆ is removed from the tension release lever 116, the tension release lever 116 returns to the static state 300, the wire hole 114 returns to the first size 400, and the wire insertion slot 118 returns to the first size 404.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A deformable wiring harness clip comprising:
a body including an interior portion, an exterior portion opposing the interior portion, a first side, and a second side opposing the first side;
a plurality of wedged teeth integrated with the interior portion of the body, each of the plurality of wedged teeth having an angle defined from the first side of the body to the second side of the body;
a wire hole defined by the plurality of wedged teeth, the wire hole operable between a first size and a second size larger than the first size;
a tension release lever integrated with the body and protruding away from the body, the tension release lever operable between a first state and a second state; and
a pair of hooks integrated with the second side of the body.

2. The deformable wiring harness clip of claim 1, wherein the first state of the tension release lever is a static state, the first state corresponding to the first size of the wire hole.

3. The deformable wiring harness clip of claim 1, wherein the second state of the tension release lever is a deformed state, the second state corresponding to the second size of the wire hole.

4. The deformable wiring harness clip of claim 1, wherein the pair of hooks include rounded tips.

5. The deformable wiring harness clip of claim 1, wherein the plurality of wedged teeth are configured to engage with a wire of a wiring harness assembly.

6. The deformable wiring harness clip of claim 5, wherein the wire has a bi-directional linear path relative to the wire hole when the tension release lever is in the second state.

7. The deformable wiring harness clip of claim 5, wherein the wire has a mono-directional linear path relative to the wire hole when the tension release lever is in the first state, the mono-directional linear path defined by movement of the wire from the first side of the body toward the second side of the body.

8. The deformable wiring harness clip of claim 5, further including a wire insertion slot defined by the tension release lever and extending from the exterior portion of the body to the wire hole.

9. The deformable wiring harness clip of claim 8, wherein the wire insertion slot is operable between a first size and a second size larger than the first size, the second size of the wire insertion slot being sized to accommodate the wire.

10. The deformable wiring harness clip of claim 1, further comprising a mounting point integrated with the body and fixedly attached to a vehicle component.

11. A vehicle component comprising:
a wiring harness assembly operable between a first position and a second position, the wiring harness assembly including:
a wire including a connector end;
a connector coupled to the connector end of the wire, the connector including a pair of hook receptacles; and
a stopper fixedly attached to the wire; and
a deformable wiring harness clip including:
a body including an interior portion, an exterior portion opposing the interior portion, a first side, and a second side opposing the first side;
a plurality of wedged teeth integrated with the interior portion of the body, the plurality of wedged teeth having an angle defined from the first side of the body to the second side of the body;
a wire hole defined by the plurality of wedged teeth, the wire hole operable between a first size and a second size larger than the first size;
a tension release lever integrated with the body and protruding away from the body, the tension release lever operable between a first state and a second state; and
a pair of hooks integrated with the second side of the body.

12. The vehicle component of claim 11, wherein the first state of the tension release lever is a static state, the wire having a mono-directional linear path relative to the wire hole when the wire hole is the first size and the tension release lever is in the first state, the mono-directional linear path defined from the first side of the body toward the second side of the body.

13. The vehicle component of claim 11, wherein the second state of the tension release lever is a deformed state, the wire having a bi-directional linear path relative to the wire hole when the wire hole is the second size and the tension release lever is in the second state.

14. The vehicle component of claim 11, wherein the pair of hooks of the deformable wiring harness clip are disposed in the pair of hook receptacles of the connector when the wiring harness assembly is in the first position.

15. The vehicle component of claim 11, wherein the pair of hooks of the deformable wiring harness clip are removed from the pair of hook receptacles of the connector and the stopper is proximate to the deformable wiring harness clip when the deformable wiring harness clip is in the second position, the stopper having a size greater than the first size of the wire hole.

16. A vehicle comprising:
a vehicle component including:
a wiring harness assembly operable between a first position and a second position, the wiring harness assembly including:
a wire including a connector end;
a connector coupled to the connector end of the wire, the connector including a pair of hook receptacles; and
a stopper fixedly attached to the wire; and
a deformable wiring harness clip including:
a body including an interior portion, an exterior portion opposing the interior portion, a first side, and a second side opposing the first side;
a plurality of wedged teeth integrated with the interior portion of the body, the plurality of wedged teeth having an angle defined from the first side of the body to the second side of the body;
a wire hole defined by the plurality of wedged teeth, the wire hole operable between a first size and a second size larger than the first size;
a tension release lever integrated with the body and protruding away from the body, the tension release lever operable between a first state and a second state; and
a pair of hooks integrated with the second side of the body.

17. The vehicle of claim 16, wherein the first state of the tension release lever is a static state, the wire having a mono-directional linear path relative to the wire hole when the wire hole is the first size and the tension release lever is in the first state, the mono-directional linear path defined from the first side of the body toward the second side of the body.

18. The vehicle of claim 16, wherein the second state of the tension release lever is a deformed state, the wire having a bi-directional linear path relative to the wire hole when the wire hole is the second size and the tension release lever is in the second state.

19. The vehicle of claim 16, wherein the pair of hooks of the deformable wiring harness clip are disposed in the pair of hook receptacles of the connector when the wiring harness assembly is in the first position.

20. The vehicle of claim 16, wherein the pair of hooks of the deformable wiring harness clip are removed from the pair of hook receptacles of the connector and the stopper is proximate to the deformable wiring harness clip when the deformable wiring harness clip is in the second position, the stopper having a size greater than the first size of the wire hole.
